(19) United States
(12) Patent Application Publication
(10) Pub. No.: US 2010/0138032 A1
(43) Pub. Date: Jun. 3, 2010

(54) METHOD AND SYSTEM FOR MERCHANDISING COMPLEMENTARY MERCHANDISE IN FLOOR SPACE REMNANTS CREATED BY PRIMARY MERCHANDISE

(75) Inventor: Russell A. Potterfield, Columbia, MO (US)

Correspondence Address: PERKINS COIE LLP;PATENT-SEA, P.O. BOX 1247, SEATTLE, WA, 98111-1247, US

(73) Assignee: Battenfeld Technologies, Inc., Columbia, MO (US)

(21) Appl. No.: 12/623,238

(22) Filed: Nov. 20, 2009

Related U.S. Application Data
(60) Provisional application No. 61/117,066, filed on Nov. 21, 2008.

(51) Int. Cl. G06F 7/00

(52) U.S. Cl. 700/213; 186/52

(57) ABSTRACT

To identify and make productive use of remnant floor space created by primary merchandise, one or more floor space remnants are identified in a floor plan of a retailer that comprises merchandise of a given product category (primary merchandise). A floor space remnant is an unused portion of floor space within a merchandising footprint of the primary merchandise. Once a floor space remnant has been identified, complementary merchandise that is associated with the primary merchandise is identified. A merchandising solution is designed to display the identified complementary merchandise in the identified floor space remnant. The merchandising solution is placed in the previously unused floor space remnant to display the complementary merchandise and make productive use of the floor space remnant.

### CROSS-REFERENCE TO RELATED APPLICATION

The present application claims the benefit under 35 U.S.C. §119(e) of U.S. Provisional Application No. 61/117,066, filed Nov. 21, 2008, the disclosure of which is incorporated herein by reference in its entirety.

### BACKGROUND

Retailers offer merchandise for sale to consumers, most commonly from a physical store location. Retailers often carry products from many manufacturers in order to satisfy consumers' varying desires regarding product selection, price, features, and other considerations. Each retailer or retail chain makes its own decisions regarding which merchandise to stock, and from which manufacturers. Each retailer or retail chain is then left to plan a layout for its store floor space, combining merchandise from several manufacturers into a cohesive and productive floor plan. Typically, the more floor space that is allocated for merchandise, the more sales that may be generated by the retailer. Productive floor plans can help retailers maximize profits and stay competitive in their markets, in addition to other benefits.

Productive floor space planning can be challenging, particularly for retailers that sell large and/or unusually shaped merchandise. Examples of such oversize merchandise include gun vaults; televisions and other large electronic equipment; appliances, such as refrigerators, washing machines, dryers, and water heaters; pet habitats, such as aquariums and cages; spas or hot tubs; and other large and/or unusually shaped merchandise. Particularly when such products come from multiple manufacturers, these large and/or unusually shaped products may be of varying shapes and sizes and may not lend themselves to arrangement in a uniform floor plan. Floor plans that accommodate these types of products may be inefficient, leaving unused, or “remnant,” floor space that is not used by the retailer for product placement, sales generation, and/or or other productive purposes.

A method and system for identifying and making productive use of remnant floor space created by a layout of primary merchandise is therefore desired.

### BRIEF DESCRIPTION OF THE DRAWINGS

FIG. 1 is a block diagram of a basic and suitable computer that may employ aspects of the method and system.

FIG. 2 is a block diagram illustrating a simple, yet suitable system in which aspects of the method and system may operate in a networked computer environment.

FIG. 3 is a flow diagram of a process that is used for merchandising complementary merchandise in remnant floor space created by primary merchandise in some embodiments.

FIG. 4 is a block diagram of an example floor plan of primary merchandise in which floor space remnants may be identified.

FIG. 5 is a block diagram of an example floor plan in which a merchandising solution has been placed in remnant floor space.

FIG. 6 is a block diagram of an alternative example floor plan of primary merchandise in which floor space remnants may be identified.

FIG. 7 is a block diagram of an alternative example floor plan in which a merchandising solution has been placed in remnant floor space.

FIG. 8 is a block diagram of an alternative example floor plan of primary merchandise in which floor space remnants may be identified.

FIG. 9 is a block diagram of an alternative example floor plan in which a merchandising solution has been placed in remnant floor space.

FIG. 10 is a block diagram of an example merchandising solution that may be designed for placement in remnant floor space.

### DETAILED DESCRIPTION

A method and system for merchandising complementary merchandise in remnant floor space created by primary merchandise is described. One or more floor space remnants are identified in a floor plan of a retailer comprising merchandise of a given product category (herein referred to as “primary merchandise”). A floor space remnant is an unused portion of floor space within a merchandising footprint of the primary merchandise. Once a floor space remnant has been identified, complementary merchandise that is associated with the primary merchandise is identified. A merchandising solution is designed to display the identified complementary merchandise in the identified floor space remnant. The merchandising solution is placed in the previously unused floor space remnant to display the complementary merchandise. Identifying and making productive use of floor space remnants may allow a retailer to increase sales, improve customer satisfaction, and achieve other benefits.

Various embodiments of the method and system will now be described. The following description provides specific details for a thorough understanding and enabling description of these embodiments. One skilled in the art will understand, however, that the method and system may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the method and system. Certain terms may even be emphasized below; however, any terminology intended to be interpreted in any restricted manner will be overtly and specifically defined as such in this Detailed Description section.

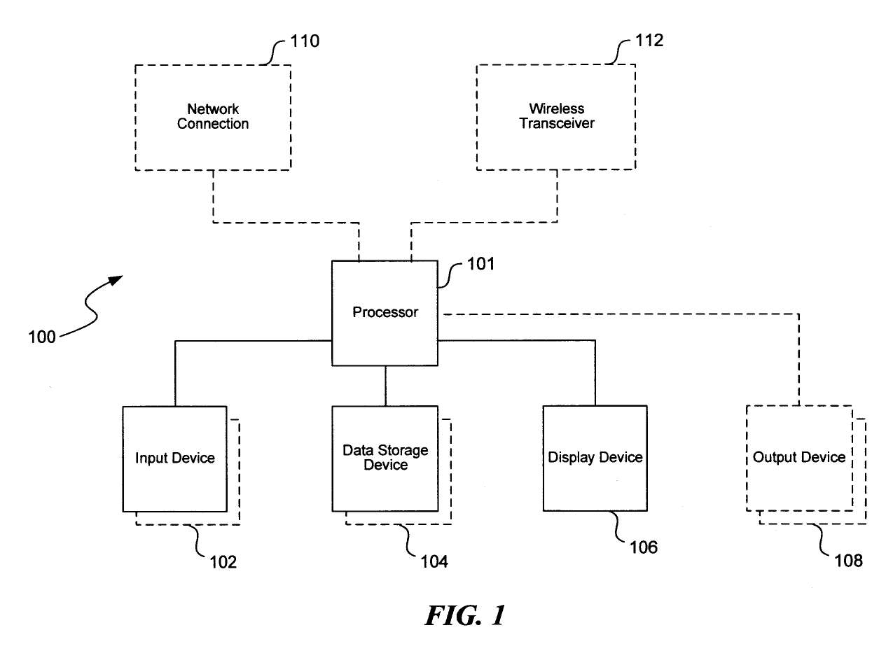

The method and system described herein may be performed on one or more computers. FIG. 1 and the following discussion provide a brief, general description of a suitable computing environment in which aspects of the method and system can be implemented. Although not required, aspects and embodiments of the method and system will be described in the general context of computer-executable instructions, such as routines executed by a general-purpose computer, e.g., a server or personal computer. Those skilled in the relevant art will appreciate that the method and system can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers, and the like. The method and system can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor or any device capable of communicating with a network, including consumer electronic goods such as game devices, cameras, or other electronic devices having a processor and other components, e.g., network communication circuitry.

The method and system can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Aspects of the method and system described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the method and system may reside on a server computer, while corresponding portions reside on a client computer. Data structures and transmission of data particular to aspects of the method and system are also encompassed within the scope of the method and system.

Referring to FIG. 1, some embodiments of the method and system employ a computer 100, such as a personal computer or workstation, having one or more processors 101 coupled to one or more user input devices 102 and one or more data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a LAN, WAN, or the Internet (not shown in FIG. 1).

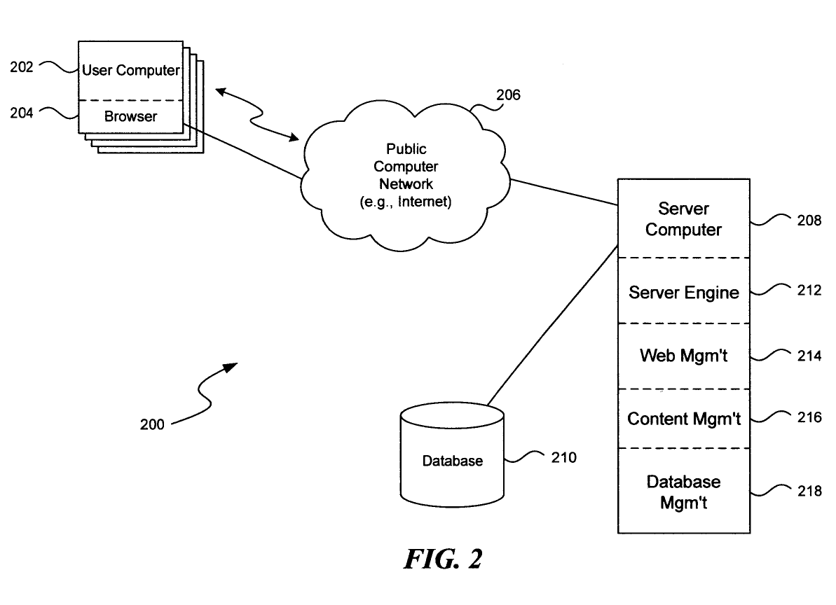

Aspects of the method and system may be practiced in a variety of other computing environments. For example, referring to FIG. 2, a distributed computing environment with a web interface includes one or more user computers 202 in a system 200, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores many of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data.

To identify and make productive use of remnant floor space created by primary merchandise, one or more floor space remnants are first identified in a floor plan of a retailer comprising primary merchandise. Once a floor space remnant has been identified, complementary merchandise that is associated with the primary merchandise is identified, and a merchandising solution is designed to display this complementary merchandise. The merchandising solution is placed in the one or more floor space remnants to make productive use of the previously unused floor space.

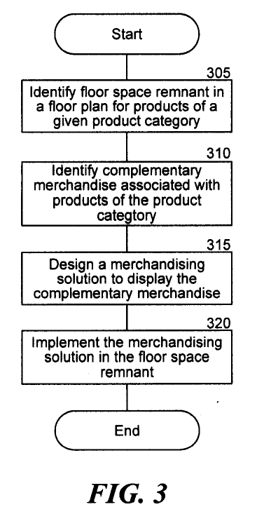

FIG. 3 is a flow diagram of a process that is used for merchandising complementary merchandise in remnant floor space created by primary merchandise in some embodiments. At a block 305, the process identifies one or more floor space remnants in a floor plan of a retailer comprising merchandise of a given product category (primary merchandise). A floor space remnant is an unused portion of floor space within a merchandising footprint of the primary merchandise. A merchandising footprint is an area of the sales floor allocated to the primary merchandise. For example, a merchandising footprint may be the area of floor space that would be enclosed if a perimeter were drawn around the primary merchandise.

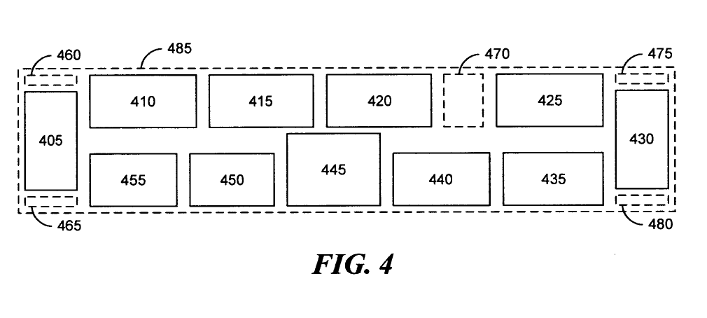

FIG. 4 is a block diagram of an example floor plan in which floor space remnants may be identified. FIG. 4 is a top view of floor space that may be allocated by a retailer for products 405-455 of a given product category. As depicted by FIG. 4, the products 405-455 may have varying widths, heights, depths (or lengths), and/or other dimensions. For example, product 445 has greater depth than the surrounding products 435-440 and 450-455. Product dimensions may vary, for example, if the products are from different manufacturers, if the products are from the same manufacturer but are from different product lines or are different models, or for other reasons. However, one skilled in the art will appreciate that the products may share identical or similar dimensions and still present floor space remnant problems. The floor plan of FIG. 4 includes a merchandise footprint of primary merchandise that is defined by a perimeter 485 enclosing products 405-455. In such a floor plan, the process may identify floor space remnants 460-480, each depicted in FIG. 4 with a broken line enclosing the floor space remnant. The floor space remnants 460-480 are currently unused by the retailer as productive floor space.

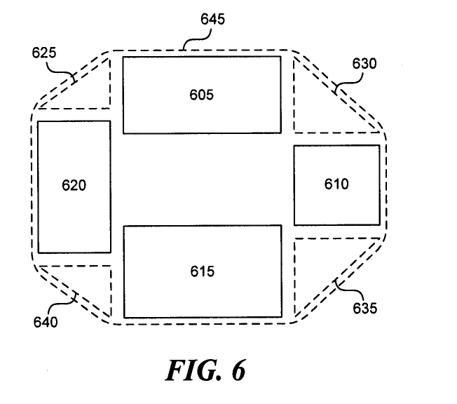

Similarly, FIG. 6 is a block diagram of an alternative example floor plan in which floor space remnants may be identified. FIG. 6 is a top view of floor space that may be allocated by a retailer for products 605-620 of a given product category. Products 605-620 may be arranged facing outward in a circular manner for a variety of reasons, including that a retailer has limited wall space available. Similar to those products depicted by FIG. 4, the products 605-620 depicted by FIG. 6 may have varying widths, heights, depths (or lengths), and/or other dimensions. The floor plan of FIG. 6 includes a merchandise footprint of primary merchandise that is defined by a perimeter 645 enclosing products 605-620. In such a floor plan, the process may identify floor space remnants 625-640, each depicted in FIG. 6 with a broken line enclosing the floor space remnant. Like the floor space remnants identified in FIG. 4, the floor space remnants 625-640 of FIG. 6 are currently unused by the retailer as productive floor space.

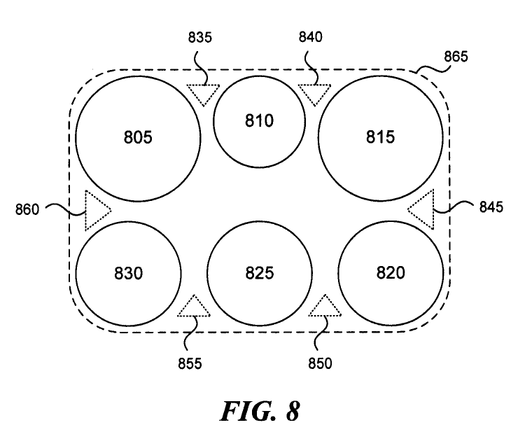

As still another example, FIG. 8 is a block diagram of an alternative example floor plan in which floor space remnants may be identified. FIG. 8 is a top view of floor space that may be allocated by a retailer for products 805-830 of a given product category. The products 805-830 may have varying widths, heights, depths (or lengths), radiuses, and/or other parameters. The floor plan of FIG. 8 includes a merchandise footprint of primary merchandise that is defined by a perimeter 865 enclosing products 805-830. In such a floor plan, the process may identify floor space remnants 835-860, each depicted in FIG. 8 with a broken line enclosing the floor space remnant. The floor space remnants 835-860 are currently unused by the retailer as productive floor space.

Different product categories and/or floor plans may create floor space remnants of different shapes and sizes. Each product category may have unique dimensions, shapes, parameters, stacking configurations, and/or other characteristics that define, in whole or in part, the floor space remnants that are created when floor space is allocated to the merchandise of the product category. For example, rectangular floor space remnants of varying sizes are created by the floor plan of FIG. 4, which comprises products that are cubic or cuboid in shape and which take up a rectangular floor space portion, such as gun vaults. Alternatively, triangular floor space remnants of varying sizes are created by the floor plan of FIG. 8, which comprises products that are cylindrical in shape and which take up a circular floor space portion, such as water heaters. In addition, different floor plans designed for merchandise of the same product category may create floor space remnants of different shapes and sizes. For example, FIGS. 4 and 6 may depict merchandise of the same product category, which comprises products that are cubic or cuboid in shape and which take up a rectangular floor space portion, such as gun vaults. While the floor plan of FIG. 4 creates rectangular floor space remnants, the floor plan of FIG. 6 creates triangular floor space remnants. One skilled in the art will appreciate that different floor space remnant shapes and sizes may also be created by a single floor plan. Floor space remnants of different sizes created by a floor plan are illustrated by FIGS. 4, 6, and 8. In addition, floor space remnants of different shapes may be created by the same floor plan, such as a first floor space remnant with a rectangular shape and a second floor space remnant with a triangular shape.

Returning to FIG. 3, once one or more floor space remnants have been identified in a floor plan comprised of primary merchandise, at a block 310, the process identifies complementary merchandise associated with the primary merchandise. Complementary merchandise includes products that can be used to accessorize the primary merchandise, products that may be desired by consumers purchasing the primary merchandise, or other products that correspond to the primary merchandise. For example, if the product category is gun vaults, complementary merchandise may include dehumidifiers, humidity gauges, interior lighting, gun storage sleeves, anchor kits to bolt or otherwise secure vaults, handgun storage racks, document organizers, and other merchandise associated with gun vaults.

Once complementary merchandise associated with the primary merchandise has been identified, at a block 315, a merchandising solution is designed to display the complementary merchandise. Considerations in designing a merchandising solution may include the characteristics of the primary merchandise, the characteristics of the complementary merchandise, the size and shape of the floor space remnant in which the merchandising solution is to be placed, and other considerations. Characteristics of primary and complementary merchandise that may be considered include size, shape, weight, materials, and other characteristics of the merchandise. In some embodiments, the merchandising solution is designed to be a freestanding merchandiser to be placed in the remnant floor space. For example, the merchandising solution may be a self-supporting merchandiser comprised of one or more racks or shelves, or may be a freestanding merchandiser designed in another manner. In other embodiments, the merchandising solution is designed to be fixed to one or more of the products comprising the primary merchandise. For example, the merchandising solution may be a merchandiser that is affixed to, abuts, or otherwise adjoins one or more of the products comprising the primary merchandise.

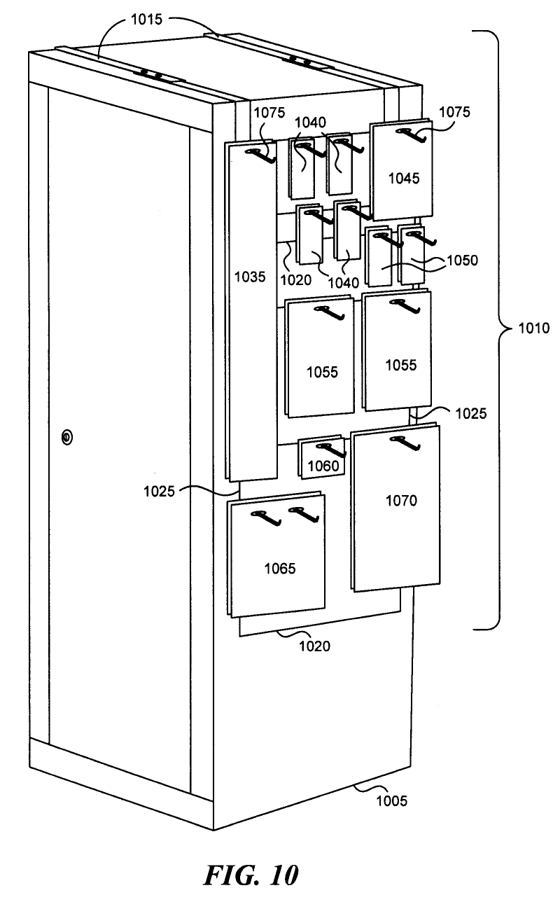

FIG. 10 is a block diagram of an example merchandising solution that may be designed for placement in remnant floor space. The depicted merchandiser 1010 is designed for use with a gun vault 1005. One skilled in the art will appreciate that the merchandiser 1010 may also be suitable for use with merchandise of other product categories, including product categories that are defined by a cube or cuboid shape and that have a substantial weight. The depicted merchandiser 1010 attaches to the gun vault 1005, such as by supports 1015 affixed to the top of the vault. The merchandiser may adjust to fit a variety of sizes of gun vaults, and may be constructed with padding to prevent scratching of or other damage to the vault. The merchandiser may securely attach to the side, back, and/or front of the vault. The merchandiser 1010 depicted in FIG. 10 is attached to the side of the vault 1005, via supports 1015 affixed to the top of the vault, as described above. In addition, the merchandiser may be constructed with a variety of horizontal rods 1020, vertical rods 1025, and peg hooks 1075 that allow a variety of shapes and sizes of merchandise 1035-1070 to be displayed on the merchandiser 1010. The rods and peg hooks may be adjustable or repositionable to accommodate the variety of merchandise shapes and sizes, in addition to changing merchandise displays. The merchandiser may also include one or more signs (not depicted in FIG. 10) that identify the complementary merchandise. For example, a sign that reads “Lockdown Vault Accessories” may be appropriate for the merchandiser 1010 of FIG. 10.

In some embodiments, merchandisers 1010 are configured for attachment to multiple sides of the gun vault 1005, such as opposing sides of the gun vault 1005. In such embodiments, merchandise is displayable on two or more sides of the gun vault 1005. Merchandisers 1010 can be attached to the vault independently of each other, or two or more merchandisers 1010 can be fastened together and attached to the vault together, such as by supports 1015 affixed to the top of the vault.

In some embodiments, the same merchandising solution may be designed for multiple stores of the same retailer and/or for multiple retailers. Alternatively or additionally, multiple merchandising solutions may be offered to a retailer and/or multiple retailers. For example, multiple merchandisers may be offered, each holding more or fewer complementary products based on the floor space remnant in which the merchandiser is to be placed. In addition, a merchandiser may be adjustable so that it can be scaled to fit differing sizes of floor space remnants. In some embodiments, the merchandising solution may comprise both a merchandiser and the complementary products that are to be displayed on the merchandiser.

Returning to FIG. 3, once a merchandising solution has been designed, at a block 320, the merchandising solution is implemented, such as by placing the merchandising solution in the one or more floor space remnants identified at block 320. For example, the merchandising solution may be placed freestanding in a floor space remnant, may be affixed to one or more primary merchandise products adjoining the floor space remnant, or may be placed in the floor space remnant in another manner.

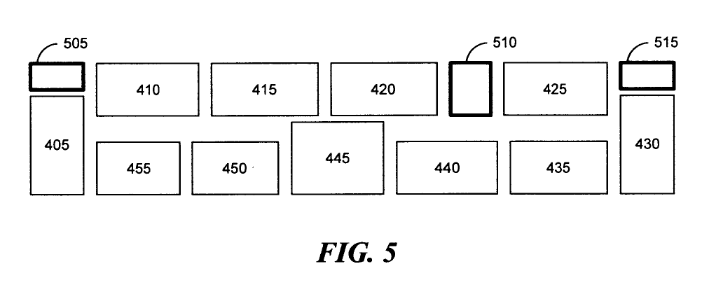

FIG. 5 is a block diagram of an example floor plan in which a merchandising solution has been placed in remnant floor space. FIG. 5 corresponds to the example floor plan of FIG. 4 in which floor space remnants were identified, as described above. As depicted by FIG. 5, primary merchandise may be moved within the merchandising footprint to consolidate floor space remnants. The floor plan of FIG. 4 includes products 405 and 430 centered on a line (not shown) extending horizontally through the middle of the merchandise footprint. Floor space remnants 460 and 465 are created on either side of product 405; and floor space remnants 475 and 480 are created on either side of product 430. By moving products 405 and 430 off of the center line, as depicted in FIG. 5, the identified floor space remnants on either side of the products may be consolidated to one side. Accordingly, merchandising solution 505 may be placed on one side of product 405, while merchandising solution 515 may be placed on one side of product 430. In addition, merchandising solution 510 is placed in the additional floor space remnant 470 that was identified in FIG. 4. In some embodiments, the floor plan may be similar to that of FIG. 4, except that it does not include product 430. In such embodiments, merchandising solution 505 may be placed on the side of product 425 and/or the side of product 435.

One skilled in the art will appreciate that not all floor space remnants need be filled with merchandising solutions. Some floor space remnants may be left unused, such as for aesthetic purposes, to prevent product overcrowding, for business reasons, and for a variety of other reasons.

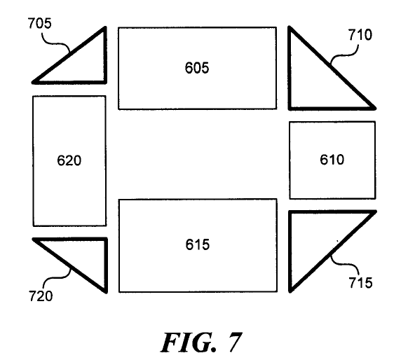

FIG. 7 is a block diagram of an alternative example floor plan in which a merchandising solution has been placed in remnant floor space. FIG. 7 corresponds to the example floor plan of FIG. 6 in which floor space remnants were identified, as described above. As depicted by FIG. 7, merchandising solutions 705-720 may be placed in the floor space remnants 625-640 that were identified in FIG. 6.

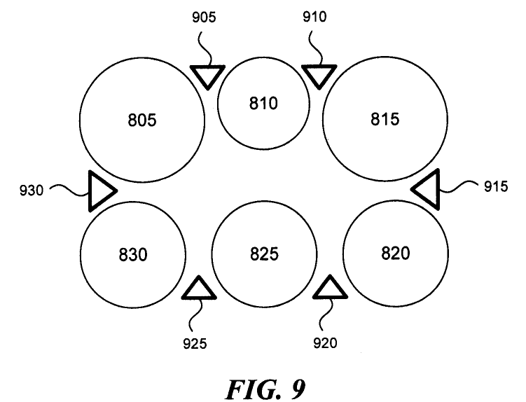

Similarly, FIG. 9 is a block diagram of an alternative example floor plan in which a merchandising solution has been placed in remnant floor space. FIG. 9 corresponds to the example floor plan of FIG. 8 in which floor space remnants were identified, as described above. As depicted by FIG. 9, merchandising solutions 905-930 may be placed in the floor space remnants 835-860 that were identified in FIG. 8. As described above, not all floor space remnants need be filled with merchandising solutions.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A computer-implemented method of merchandising complementary merchandise in one or more floor space remnants within a floor plan comprising primary merchandise, the method comprising:
identifying one or more floor space remnants of a floor plan of a retailer, wherein the floor plan comprises primary merchandise of a given product category, and wherein each of the one or more floor space remnants comprises an unused portion of floor space within a merchandising footprint of the primary merchandise;
identifying complementary merchandise that is associated with the primary merchandise;
designing a merchandising solution to display the identified complementary merchandise in the identified one or more floor space remnants; and
placing the merchandising solution in the identified one or more floor space remnants, the merchandising solution displaying the identified complementary merchandise.

2. The method of claim 1 wherein the merchandising footprint is an area of floor space enclosed by a perimeter of the primary merchandise.

3. The method of claim 1 wherein the primary merchandise comprises products with varying widths, heights, and depths.

4. The method of claim 1 wherein the primary merchandise comprises products from different manufacturers.

5. The method of claim 1, further comprising:
identifying one or more floor space remnants of a second floor plan of a retailer, wherein the second floor plan comprises primary merchandise of a second product category, wherein each of the one or more floor space remnants comprises an unused portion of floor space within a merchandising footprint of the primary merchandise of the second product category.

6. The method of claim 5 wherein the second product category is the same as the given product category, and wherein at least one of the identified one or more floor space remnants of the floor plan differs in size or shape from at least one of the identified one or more floor space remnants of the second floor plan.

7. The method of claim 5 wherein the second product category is different from the given product category, and wherein at least one of the identified one or more floor space remnants of the floor plan differs in size or shape from at least one of the identified one or more floor space remnants of the second floor plan.

8. The method of claim 7 wherein the second product category comprises products with different dimensions, shapes, parameters, or stacking configurations from products of the given product category.

9. A system for merchandising complementary merchandise in one or more floor space remnants created by a layout of primary merchandise, the system comprising:
means for identifying one or more floor space remnants of a layout of primary merchandise, wherein the primary merchandise comprises products of a given product category, and wherein each of the one or more floor space remnants is an unused portion of floor space within the layout of the primary merchandise;
means for identifying complementary merchandise that is associated with the primary merchandise;
means for designing a merchandising solution to display the identified complementary merchandise in the identified one or more floor space remnants; and
means for placing the merchandising solution in at least one of the identified one or more floor space remnants, the merchandising solution displaying the identified complementary merchandise.

10. The system of claim 9 wherein the given product category is gun vaults.

11. The system of claim 9 wherein the complementary merchandise comprises products that are usable to accessorize the primary merchandise.

12. The system of claim 9 wherein the complementary merchandise comprises products that are desirable to consumers purchasing the primary merchandise.

13. The system of claim 10 wherein the complementary merchandise is selected from a set consisting of dehumidifiers, humidity gauges, interior lighting, gun storage sleeves, anchor kits, handgun storage racks, and document organizers.

14. The system of claim 9 wherein the means for designing the merchandising solution includes considering the characteristics of the primary merchandise, the characteristics of the complementary merchandise, and the sizes and shapes of the one or more floor space remnants.

15. The system of claim 9 wherein the merchandising solution is a freestanding merchandiser to be placed in at least one of the one or more floor space remnants.

16. The system of claim 9 wherein the merchandising solution is a merchandiser that is to be fixed to one or more products comprising the primary merchandise.

17. A method of merchandising complementary merchandise in one or more floor space remnants within a floor plan comprising gun vaults, the method comprising:
identifying one or more floor space remnants of a floor plan of a gun vault retailer, wherein the floor plan comprises gun vaults, and wherein each of the one or more floor space remnants comprises an unused portion of floor space within a merchandising footprint of the gun vaults;
identifying complementary merchandise that is associated with the gun vaults;
designing a merchandising solution to display the identified complementary merchandise in the identified one or more floor space remnants; and
placing the merchandising solution in the at least one of the identified one or more floor space remnants, the merchandising solution displaying the identified complementary merchandise.

18. The method of claim 17 wherein the complementary merchandise is selected from a set consisting of dehumidifiers, humidity gauges, interior lighting, gun storage sleeves, anchor kits, handgun storage racks, and document organizers.

19. The method of claim 17 wherein the merchandising solution is a merchandiser that is affixed to at least one of the gun vaults.

20. The method of claim 19 wherein the merchandiser is adjustable to fit a variety of sizes of the gun vaults.

21. The method of claim 19 wherein the merchandiser attaches to the side, back, or front of the at least one gun vault via supports affixed to the top of the gun vault.

22. The method of claim 19 wherein the merchandiser includes horizontal rods, vertical rods, and peg hooks that allow a variety of shapes and sizes of the complementary merchandise to be displayed on the merchandiser.

23. The method of claim 22 wherein the horizontal rods, vertical rods, and peg hooks are adjustable.

24. The method of claim 19 wherein the merchandiser holds more or fewer products of the identified complementary merchandise based on the identified one or more floor space remnants.

25. The method of claim 19 wherein the merchandising solution further comprises the identified complementary merchandise to be displayed on the merchandiser.
